(19) United States
(12) Patent Application Publication
(10) Pub. No.: US 2014/0088991 A1
(43) Pub. Date: Mar. 27, 2014

(54) HEALTHCARE COMMUNICATION SYSTEM

(71) Applicant: RxPlainER, LLC, Morrison, CO (US)

(72) Inventors: Peter Bakes, Morrison, CO (US); Chris M. Holmes, Evergreen, CO (US); Dylan R. Luyten, Denver, CO (US)

(73) Assignee: RxPlainER, LLC, Morrison, CO (US)

(21) Appl. No.: 14/031,796

(22) Filed: Sep. 19, 2013

Related U.S. Application Data
(60) Provisional application No. 61/704,297, filed on Sep. 21, 2012.

(51) Int. Cl. G06F 19/00

(52) U.S. Cl. CPC G06F 19/3418
USPC 705/2

(57) ABSTRACT

A healthcare communication system disclosed herein facilitates communications with patients in healthcare setting using a web-based application using one or more desktop and/or mobile devices. Specifically, an implementation of the system provides a web-based application that delivers patient communication content to a patient mobile device within healthcare settings, such as patient waiting rooms at hospital emergency departments, clinics, inpatient facilities, etc. The system also coordinates the communication with the patients, nurses, friends and relatives of the patient, etc.

### FIELD

Implementations disclosed herein relate, in general, to information management technology in general and specifically to managing healthcare communications.

### SUMMARY

A healthcare communication system disclosed herein facilitates communications with patients in healthcare setting using one or more mobile devices. Specifically, an implementation of the method provides selecting from a plurality of patient communication content, delivering the selected patient communication content to a patient, monitoring viewing of the patient communication content by the patient, automatically generating, using a processor, a feedback based on the viewing of the patient communication content by the patient, and distributing the feedback to one or more of a plurality of healthcare system participants. In an implementation provided herein enables different users to be aware of communication delivered to patient and therefore avoiding redundant communication and safeguarding necessary communication. Another implementation of the system also coordinates communication between a hospital information system, government payers, third party payers, hospital administrators, social media, and patients

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing a healthcare communication system.

FIG. 2 illustrates an alternative example block diagram representing a healthcare communication system.

FIG. 3 illustrates an example flowchart of various operations performed by the healthcare communication system disclosed herein.

FIG. 4 illustrates an example block diagram of various participants in the healthcare communication system.

FIG. 5 illustrates an example user interface that may be used by the healthcare communication system.

FIG. 6 illustrates an alternative example flowchart of various operations performed by the healthcare communication system disclosed herein.

FIG. 7 illustrates an alternative example user interface that may be used by the healthcare communication system.

FIG. 8 illustrates an example computing system that can be used to implement the healthcare communication system disclosed herein.

FIG. 9 illustrates an example mobile computing device that can be used to implement one or more components of the healthcare communication system disclosed herein.

### DETAILED DESCRIPTION

In a chaotic emergency department, clinic or inpatient setting, physicians and nurses must effectively communicate with patients to provide sound care. The combination of providers short on time and patients with varying degrees of medical literacy frequently leads to suboptimal communication.

A healthcare communication system disclosed herein provides a means for communicating between the patients, healthcare providers, healthcare administrators, friends and relatives of the patients, and other related parties. Specifically, an implementation of the healthcare communication system allows various parties to communicate with patients using mobile devices. For example, the healthcare communication system allows a healthcare service provider to send communications to a patient. Alternatively, a patient may communicate with the nurses, doctors, administrators of a healthcare provider, insurance company representative, etc., using a smartphone, a tablet computer, a laptop, etc. Alternatively, devices that are not connected wirelessly, such as terminals of computers installed in the hospital such as nurse or physician desktops, waiting room, etc., may also be used

Yet alternatively, the patients may be able to access the healthcare communication system remotely using their home computers or other communication tools. The system also provides streaming multimedia content to the patients and other users to educate the users about their healthcare needs. Thus, for example, if a patient is admitted to a hospital for care related to chest pain, while the patient is waiting to receive care, the system may provide a questionnaire to gather further information from the patient. For example, a questionnaire asks the patient to provide information, such as the patient's birthdate, medical history, etc. Furthermore, such questionnaire may be based on the patient's healthcare need, thus asking the patient about chest pain history, heart related illnesses in the family, chest related illness in family, etc. Yet alternatively, the questionnaire may also adapt various questions based on answers from the patient.

Furthermore, the system also provides a suite of multimedia communication to the patient that is suited to the patient's individual case. For example, given the patient is a male patient in his sixties with a history of diabetes in the family, the system presents videos related to prevention of diabetic attacks, videos related to cooking with low sugar, exercising appropriate for the age and the condition of the patient, etc. Furthermore, not just the selection of multimedia content, but the order and grouping of the multimedia content may also be tailored for each patient based on the patient condition or patient related information. For example, the system selects the multimedia content to be presented to a patient based on patient's health complaints, demographics, patient response to therapy, results of diagnostic tasting for the patient, etc. Other external factors, such as weather conditions, prevailing epidemics or infectious diseases, etc., are also taken into consideration when selecting the multimedia content to be presented to the patient.

Furthermore, the multimedia content presented to the patient may be selected by medical experts and delivered to the patient in real-time based on patient demographics and patient complaints. In an alternative implementation, such content is updated dynamically based on new information, such as test results, change in patient condition, etc. For example, a test result received when a patient is waiting for healthcare result may be presented to the patient via the tablet of other device used for delivery of the content. Yet alternatively, if a friend or family member of the patient arrives when a patient is visiting, the patient may be notified.

An implementation of the system also collects other information about the patient when the patient is reviewing the multimedia content. For example, if the patient with attention deficit disorder is provided a selection of videos, the system collects the attention of the patient to each of the videos to determine information about patient's state of mind. Such information may be communicated to the doctor, nurse or other healthcare service provider before the patient meets such service provider.

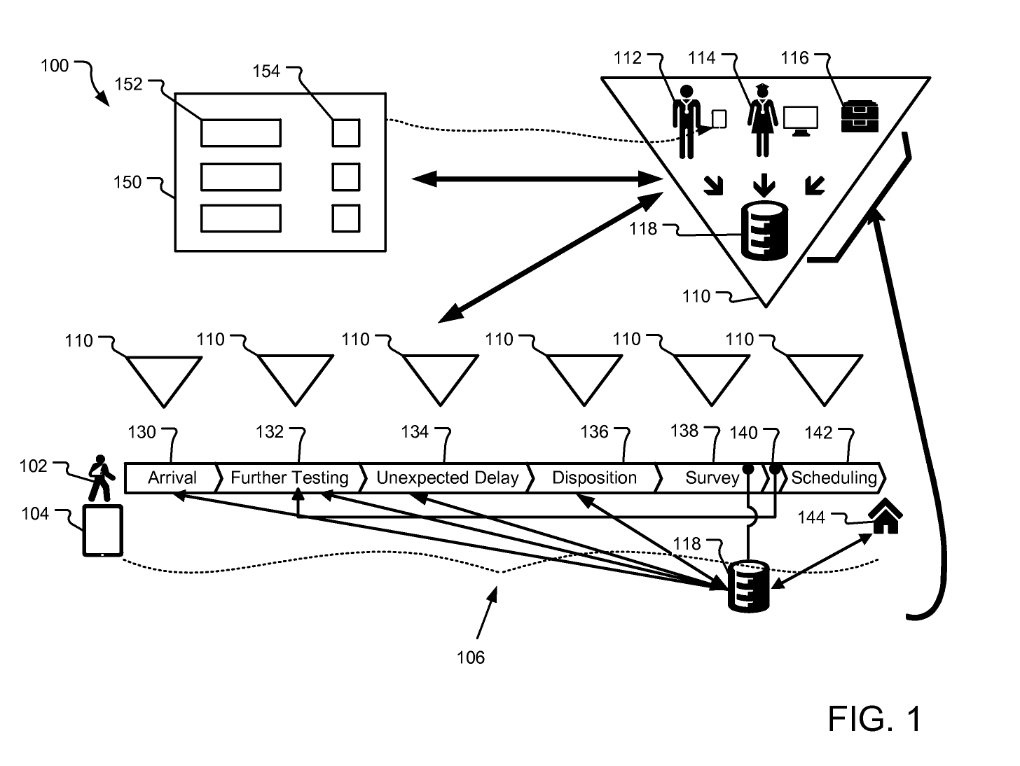

FIG. 1 discloses an example implementation of a healthcare communication system 100 for providing communication between users, including patients, healthcare providers, etc. The healthcare communication system 100 provides a communication platform to facilitate team-based communication among various users in a healthcare system, such as patients, healthcare providers, administrators, etc. Furthermore, the healthcare communication system 100 also allows providing education to the patients related to their health condition, the expected treatment, etc., using a mobile device, such as a tablet, a smartphone, a laptop, etc. For example, a patient 102 visiting a healthcare facility for a treatment maybe given a tablet 104 that is used by the various users to provide information to the user 102.

The patient 102 is provided the healthcare service, healthcare education, and other services by a healthcare system 80. In one implementation, the healthcare system 80 is illustrated to include one or more physicians 82, nursing staff 84, a hospital information system 86, etc. Each of such participants 82-116 communicate with each other, with the patient 102, and other users of the healthcare communication system 100 using various computing devices such as cellphones, smartphones, tablet devices, laptops, desktops, etc. The healthcare system 80 also includes a server 118 that can store and facilitate communication between various users. For example, the server 88 maybe a configured to have one or more software modules that process information provided by various users, communicate the information to the various users, etc. For example, the participants 82-116 may interact with the patient 102 to welcome the patient 102 to the healthcare facility and communicate information about a medical condition, the patient's lab results, etc. In one implementation, the server 88 is also communicatively coupled via a communication network, such as the Internet to other information sources, such as an insurance information provider, a government healthcare database, etc.

In one implementation, the healthcare communication system 100 communicates with the patient 102 at various stages of the patient's experience (also referred to as an episode 106) with the healthcare communication system 100. For example, a patient 102, named John Smith, may be visiting the healthcare facility for assistance related to a heart condition. In such a case, when John arrives 130 at the hospital, a member of a healthcare team, such as an administrative assistant, technician, a nurse, a doctor, etc., provides the tablet 104 to John. The healthcare communication system 100 provides an introductory video to John via the tablet 104. Such an introductory video may be selected based on various information provided by John. For example, John can provide his age, demographic information, healthcare history, symptoms, etc., using the tablet 104.

In one implementation, the system 100 uses the patient demographics and responses to questionnaire within a proprietary algorithm to determine level of medical literacy and informational needs. For example, the system 100 uses John's level of medical literacy and informational needs to guide further communication to John (e.g. if John is 47 year old with high school education and works as registered nurse assistant and therefore wants to be told “everything,” he would be provided higher content compared to some other patient that is than 74 year old retired engineer who speaks English as a second language).

In an alternative implementation, the demographic and the patient condition are also used to select and present banner ads, links to other websites, or other tailored content particular to the patient 102, etc., around the patient communication content. For example, if the patient 102 is a mother with a child having fever, a banner ad for children's Tylenol may be presented together with the educational content, as long as such presentation is allowed by appropriate regulation.

In one implementation, the person delivering the patient communication content to John is based on a predetermined assignment of role. For example, an administrative assistant working for the healthcare system 110 is assigned a role to deliver a patient admission video, an an emergency room technician is assigned the role of delivering a laboratory test video, a physician is assigned the task of delivering a patient diagnosis explanation video, etc.

In an alternative implementation, once John has provided various patient information such as his demographic data, symptom data, etc., the healthcare communication system 100 communicates with one or more external data source, such as a data source providing social network data related to John to collect other information identifying John and his condition. In such as case, a patient communication video delivered to John may be determined based on such social network data. For example, if John has symptoms related to Lyme disease and the social network data indicates that John was camping in last week, the healthcare communication system 100 may select a patient communication video that explains the Lyme disease to John.

Yet alternatively, the selection of the patient communication video is based on one or more patient communication regulations. For example, if John is admitted with symptoms that relate to human immunodeficiency virus (HIV) related illness, John may be presented with a video that illustrates his privacy choices before any test is administered to John. Subsequently, the viewing of such video by John is archived to establish the compliance of the healthcare system 110 with any regulations related to HIV related treatment. Yet alternatively, the selection and delivery of the content may be based on one or more insurance regulations.

The information provided by John is communicated in a wireless manner to the server 118 and stored therein. One or more software programs residing on the server 118 processes the information provided by John to make various determinations. For example, a video selection program implemented on the server 118 analyzes the patient information provided by John to determine that a video to be sent to John should be in Spanish language. Such program may also take other information in account. For example, if the server 118 determines that there is a particular health advisory issued by the center for disease control (CDC) about a condition with symptoms similar to that indicated by John, the video selection program takes into consideration the advisory before selecting the video to be displayed to John.

While in one implementation, such selection of the video to be communicated to John is done automatically, in an alternative implementation, the video selection program may send a communication, such as an instant message, an email, a text message, etc., to a nursing assistant, an ER technician, an administrative assistant, etc., to get additional input, approval, etc. For example, the video selection program may ask additional questions of the nursing assistant before selecting the video. Alternatively, the video selection program may provide a selection of videos to the administrative assistant for further selection and the administrative assistant may be required to authorize such communication before it is sent to John.

Subsequently, as John's episode 106 progresses, updated communication is provided to John. For example, if further testing 132 is required for John, the server 118 sends communication to the tablet 104 informing John of the tests that are required. Additionally, such communication may also provide information about the reasons for the test, the modality of the test, the timing for the test, etc. For example, after analyzing John's patient information together with other data, if it is determined that John should undergo a chest x-ray, an informational video is presented to John about such as test, including how it is performed, the expected results, etc. Additionally other information about what John is required to do for getting the x-ray test, the timing and location of the test, etc., may also be provided to John via the tablet 104.

Throughout the patient episode 106, the videos communicated to John may be selected based on various information collected during the episode 106. For example, the results of lab test may be an input that is used in selecting the next video presented to John. For example, if John was visiting for an injury to his leg and an x-ray administered to John verifies a fracture, a particular video relating to fracture is presented to John. A few examples of condition based decisions for monitoring of videos are presented below:
IF (xray=fracture & dispo=home) {video=fracture home & link to schedule follow-up appointment}
IF (dispo=admit) {video=admit to hospitalist}
IF (d-dimer=positive & creat<1.5 & allergy to contrast=false) {video=CT+D-dimer}
IF (labs pending=true & time>90 min) {video=sorry for delay}

Thus, if the disposition of the patient 102 is “admit” than a video related to admission to the hospital is presented to the patient, if there is a lab result pending and the result is delayed beyond the expected time of 90 minutes, a video explaining the reasons for the delay with appropriate apology is presented to the patient 102. Similarly, if a laboratory result for d-dimer is positive and a test for creatinine shows levels below 1.5 and an allergy test is false a particular video for CT scan and explaining the D-dimer results is presented to the patient 102.

Furthermore, the presenting of such updated communications to the patient is conducted in a team based manner such that when a communication is presented to John, updates are provided to the physician, the nursing assistant, the hospital administrator, etc. Thus, as soon as a lab result is received, the results are provided to the healthcare system participants together with the information about the communication provided to the patient. Furthermore, various feedback provided by the healthcare participants is also shared among other participants. Thus, if the nursing assistant had provided a feedback to the patient 102 explaining the lab results, such communication is shared among the other participants so they do not have to repeat the same feedback. Such automated updates and sharing of feedbacks allow for the healthcare participants from having to provide redundant communications to the patient. In an alternative implementation, a dashboard of the healthcare communication system 100 provides visual information regarding communications delivered to the patient 102, thereby avoiding redundant communication to the patient 102.

In one implementation of the healthcare communication system 100 the system monitors the viewing of the patient communication content by the patient 102 and generates a feedback value. A patient communication content viewing matrix 150 illustrating the list of patient communication content 152 and the viewing status 154 of such content is generated. For example, the listing has all the patient communication content that is viewed by the patient 102 identified with a green symbol, whereas any patient communication content that is not viewed by the patient 102 is illustrated using a red symbol. Subsequently, such matrix 150 is delivered to various user devices, such as the physician's smartphone, the nursing assistant's smartphone, etc. As additional patient communication content is delivered and viewed, the matrix 150 is updated automatically.

The automatic generating and delivery of the patient communication content viewing matrix 150 allows various participants of the healthcare system 110 to receive continuous update on the user status and user education status. Thus, when Dr. Johnson approaches the patient 102, she can review the matrix 150 on her smartphone to ascertain what the patient 102 knows about his condition so as to avoid unnecessary repetition.

In an alternative implementation, if the patient 102 had indicated a question or provided a comment in response to viewing of a particular patient communication content, the matrix 150 may also include an additional note (not shown) that prompts the healthcare participant to view such note or question and respond to the patient 102. For example, if John is in the hospital for a heart condition is provided a video regarding angioplasty, while viewing such a video, John may have noted additional questions in response to viewing such video. In such a case, by selecting the symbol next to the listing 152, the physician can review the question and provide answer to John. Furthermore, once such a question is resolved, the physician may remove the additional symbol representing the question from the matrix 150.

The healthcare communication system 100 is communicatively connected to various facilities of the healthcare provider, such as scheduling system, laboratory system, etc. As a result, information received from these other systems is processed to determine if any additional communication is to be provided to John. For example, if doctor Mary Johnson was expected to treat John and it is determined based on the information from the scheduling system that Dr. Johnson is behind on his schedule, information about such unexpected delay 134 is also communicated to John via the tablet 104. Similarly, if John is expected to receive results from a testing laboratory at a certain time and if such results are unexpectedly delayed, a communication may be sent to John via the tablet 104.

In one implementation of the healthcare communications system 100, all of the communications provided to John via the tablet 104 is recorded and saved on the server 118. Furthermore, updates about such communications are also sent to other participants of the healthcare system 110. For example, if Adam is assigned to be the nurse for John and Dr. Johnson is assigned to be the physician for John, updates are sent to devices used by Adam and Dr. Johnson about the communications sent to John. For example, a smartphone application used by Adam and Dr. Johnson may provide the status of various communications to John. Furthermore, any inputs provided by John may also be communicated to such other participants. For example, if John decided not to watch a particular video, such action by John is communicated to the participants.

Such updating of communications provided to the other participants allows them to determine the current status of John. For example, when the nurse Adam meets patient John, if Adam knows that John has already seen the video on the timing of the x-ray test, Adam does not have to repeat such information. Furthermore, such communications also allows a healthcare provider to comply with various regulations related to patient communication. For example, if John has already been presented with a video regarding the symptoms a particular invasive diagnostic test related to heart attack, the viewing of such video may be recorded on the server and may be used as part of compliance record.

The healthcare communication system 100 also provides communications to the patient 102 at a discharge stage 136. For example, when John is being discharged from the hospital after being treated for a heart condition, the video selection program selects one or more videos related to the suggested lifestyle, diet, exercise regime, etc., for John post-discharge. For example, the video selection program may select such videos based on the severity of the John's condition, the treatment, etc. Alternatively, such videos may also be provided to one or relatives, friends, caretakers, etc. Thus, if John is required to be under supervision of a caretaker at home 144, such communication may be provided to such caretaker. The healthcare communication system 100 also includes various web-based interfaces such that such communication videos may be viewed by John and other users from a variety of different locations, such as while in the hospital, at home 144, etc.

Yet alternatively, upon discharge of the patient 102, the healthcare communication system 100 may also send coupons for products and services that may be used by the patient during the recuperation stage. Alternatively, the patient 102 may also send email reminders about follow-up appointments, etc.

The healthcare communication system 100 also provides surveying 138 from patients and users to collect information about the efficacy of the system and to further improve communication to the patients. In one implementation, one or more online surveys are presented to the patient 102 after discharge of the patient from the facility. Alternatively such surveys may be presented at various other instances throughout the patient episode, such as at the admission stage, after providing a particular treatment, etc. Yet alternatively, such surveys are presented to other healthcare system participants, such as nurses, physicians, administrators, friends and family of the patient, etc. The information collected by such surveys can be used not only for improving patient communication but also patient treatment and patient experience. Furthermore, the server 118 also stores data for legal purposes, such as to satisfy requirement for patient communication, options given to patient, patient choices, etc. Furthermore, the server 118 also stores data that mitigates medico-legal risks because records of the specific communications provided to the patient are stored for future queries.

In one implementation, various communications to the patient 102 during the patient episode are archived 140 on the server 118. Furthermore, the patient 102 is also given access to such communications together with other information. As a result the patient 102 may view the video communications about his or her condition, tests, treatment, post-treatment regimen, etc., at future points in time from any location using a web-enabled interface. Furthermore, the patient 102 is also given access to scheduling 142 module via such interface so that the patient 102 may schedule follow-up appointments, laboratory tests, etc.

The server 118 also hosts a number of other programs that analyzes the data generated throughout the patient episode and generates a number of outputs. Such output includes utilization of the patient communication by the patients, by providers, patient satisfaction for various aspects of healthcare including but not limited to healthcare tem, quality of care, etc. Such analysis results in improvement in patient care, patient satisfaction, patient understanding, etc.

The healthcare communication system 100 allows a healthcare provider to improve quality of care provided to its patient by improving patient/caregiver care experiences, which is enhanced with video communication. The enhanced care coordination provides the ability to email and or IM other providers involved in the care of the patient such as admitting team accepting care of patient, specialists providing consultation, and follow up doctors providing for more seamless transitions of care. The IM or email content may be pre-formatted allowing for custom editing. The healthcare communication system 100 also improves patient safety with improved patient adherence. The healthcare communication system 100 also improves preventive health focus by using videos depending on patient risk factors and video content and links to other content provided to patient via real-time videos or at-home interface. The system also allows explaining safety procedures and resources for the particular at-risk population by providing patients and their families via real-time videos and/or at-home interface.

In an alternative implementation, the healthcare communication system 100 provides teach-me-back surveys, which assesses patient comprehension and notifies medical provider of failure of patient allowing medical provider to provide further education prior to patient leaving the health care setting. An alternative implementation uses algorithms to channel appropriate resources to address misunderstanding. For example, if a patient incorrectly answers questions about medications, an immediate message is sent to the pharmacist in the department who could provide bedside education. Similarly, if a patient did not understand his diagnosis, a physician or advanced practice provider is given a message to re-educate the patient.

Furthermore, the healthcare communication system 100 also allows for using surveys created by particular health care setting to represent custom content combined with established commercially available or government surveys. Similarly, analytics may be performed on those surveys based on patient demographics including patient chief complaints, age, time of day, insurance status, specific providers involved in patients care, etc.

Yet alternatively, patients can access their content from home including links to vetted medical information relevant to their particular presentation (i.e. their chief complaint, testing, procedures, diagnosis), which leads to at-home access to customized content. Such at-home interface may also allow for links to social media, affiliates or partners of the healthcare provider, etc. Such controlled media viewing experience allows a healthcare provider in branding its image through start page, RSS, Adblocks, etc. In one implementation, advertising is monitored to ensure controlled Internet experience tailored to patient presentation and course. For example targeted ads for mother of child with fever going home for over-the-counter remedies, nearest pharmacy or a person with sprained ankle for pain reliever, medical supply store or pharmacy for supplies, etc. (NOT based on search terms or cookies, rather patient presentation and course) may not only generate revenues, but it may also enhance the patient's knowledge base and patient experience. Such targeted advertising may also be available on the interface provided at the healthcare facility, such as an ER, etc.

An implementation of the system 100 allows a patient to opt-in or opt-out of the database generated as a result of the patient's interaction with the system. For example, a patient may decline to receive any e-mail as a result of the patient's viewing the content provided by the system. Yet alternatively, the system 100 allows a user to schedule follow-up appointments with the provider, its affiliate, etc. In such a case, the information collected by the system may be shared with such an affiliate.

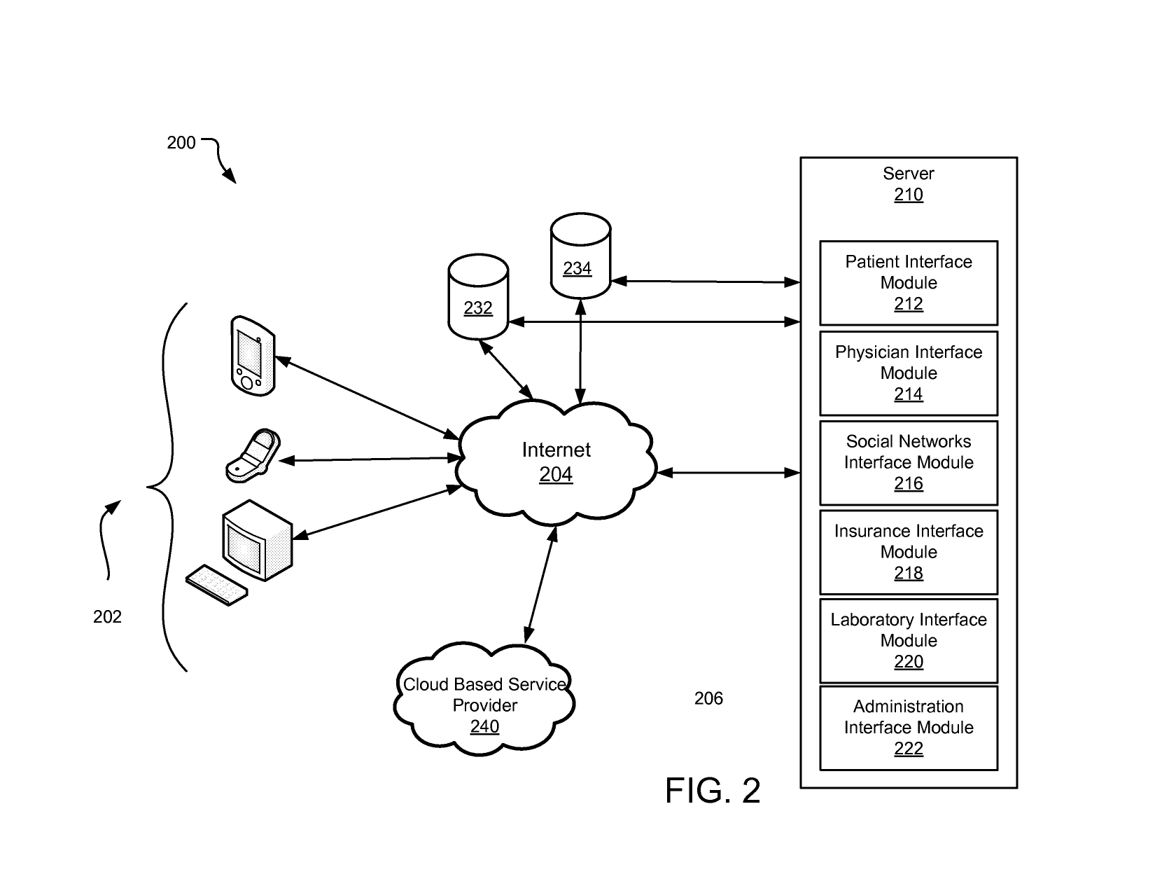

FIG. 2 discloses a healthcare communication system 200 that can be used to provide healthcare information to a plurality of users. The healthcare communication system 200 includes a healthcare information server 210 including one or more module that may be used to implement the healthcare communication system 200. In one implementation, the server is configured to communicate with a network, such as the Internet 204 and one or more other servers 232, 234. The servers 232, 234 may be used to provide updated data to the healthcare information server 210, such as unexpected delays, test results, questions, updated multimedia content related to various healthcare conditions, etc. In one implementation, various users, such as patients, physicians, friends and family of patients, etc., may be able to access the healthcare information server 210 using various devices 202, such as a smartphone, a computer, a tablet, etc.

In one implementation, the healthcare information server 210 also includes a patient interface module 212 that allows various patients and/or the patients' friends, families, and other representatives to access various patient information as well as various multi-media content. For example, such patient interface module 212 may be implemented using one or more web pages on a website, an application on a tablet, an application on a smartphone, etc. Similarly a physician interface module 214 allows a physician or a physician's representative to provide information to be communicated to the patients. The physician interface module 214 also allows a physician to select, add, or change the multimedia content to be presented to the patient. Thus, if the physician determines that a result of a diabetes test for a patient is positive, the physician may select a video that informs and educates the patient about dealing with diabetes.

In an alternative implementation, a social networks interface module 216 also collects patient information, with permission from the patient, from the patient's social network accounts to identify the patient's lifestyle, family history, recent activities, etc. Alternatively, the social networks interface module 216 may also present information content on such network, with permission from the patient, on behalf of the patient. An insurance interface module 218 allows a patient to provide insurance information to the healthcare provider. Thus, while a patient is waiting in visiting area, the patient can provide such information using an interface presented by the insurance interface module.

Similarly, a laboratory interface module 220 allows various laboratories affiliated with the healthcare provider to receive and provide information from and to the patient. An administration module 222 allows the administration of the healthcare provider to interact with the patient and provide information and media content to the patient via devices 202. In one implementation of the healthcare communication system 200, the Internet may also be connected to a cloud based service provider 240 and one or more of the modules 212-222 may be implemented on a cloud.

In an alternative implementation of the healthcare communication system 200, the server 210 generates and provides individualized Internet experience (particular advertising, RSS feed, and/or scheduling for follow-up) for patient reflecting analytics based on patient chief complaint and demographics. For example, a patient with primary care doctor within particular healthcare system gets hospital branded advertising, particular sponsor or affiliate advertising, and opportunity to schedule follow up appointment with hospital affiliated physicians.

In another alternative implementation, messaging or content sent to the patient via the devices 202 may be targeted to an ER course based on interfacing with hospital information system. For example, if a patient has urinalysis ordered but not received after one (1) hour, then automatic message is generated to provide a reminder to the patient. Similarly, if the patient has a CAT scan ordered and not completed in two (2) hours, the patient gets automatic reminder/message about the unexpected delay.

In another alternative implementation, the patient interface module 212 allows a patient to communicate status of their condition to initially evaluating emergency room doctor, hospital representative, primary-care doctor and/or follow up specialist after the patient has been discharged. Thus, the patient can access the healthcare communication system using a home computer, tablet, etc., to interact with the service provider to update about his or her health status.

In another alternative implementation, during their patient's stay at the healthcare provider, such as an ER, patients can use a tablet or other similar device to authorize communication forwarding to family members via SMS, email, or cellphone. For example, if a patient wants the nurse to send the inpatient room assignment to a family member, then the patient can authorize such communication to be forwarded to a family member. If a patient wants the doctor to send a message to a family member updating the family member on a patients' condition, then the patient can authorize such communication as well.

The feedback operation 212 provides a process for receiving and processing patient complaints and comments in real time. Such feedback from patients can be processed in real time to notify the appropriate personnel as necessary. This allows for immediate service recovery with actionable recommendations based on survey results. An implementation of the system uses algorithms to channel dissatisfied patient complaints to appropriate recipients. For example, if a patient indicated dissatisfaction with the cleanliness of the facility, an immediate message would be sent to housekeeping staff. Whereas if a patient was dissatisfied with nursing care, an immediate message would be sent to nursing supervisor. Additionally, survey data is collected to both confirm understanding of subject matter and quantify patient satisfaction. This data is analyzed in real time via a proprietary algorithm and feedback is given to providers to ensure patient comprehension and satisfaction during the course of the health care stay.

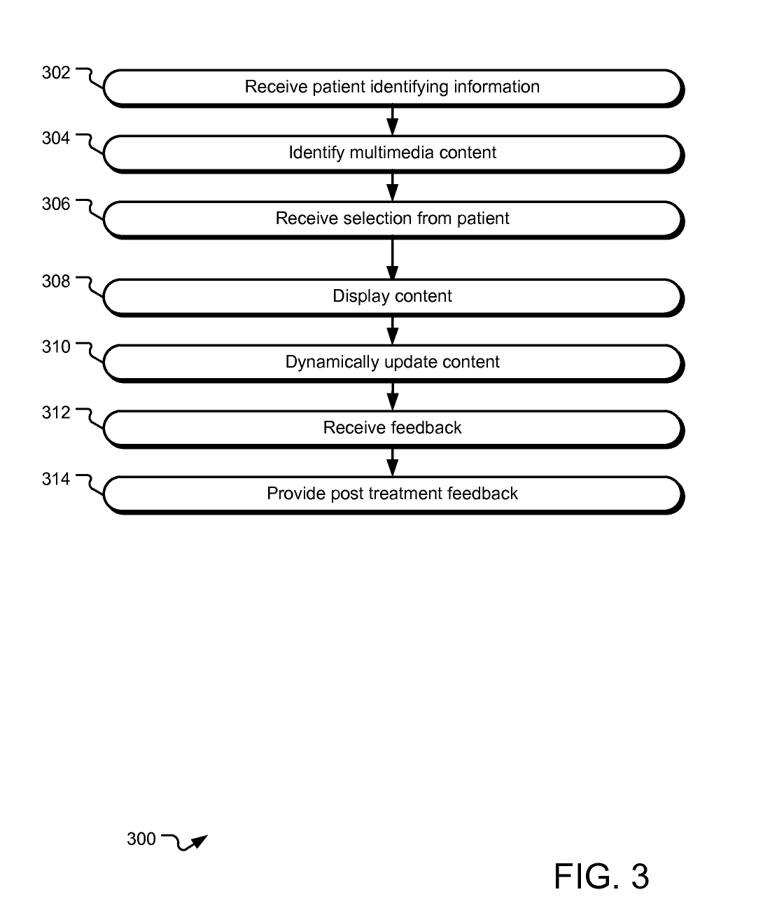

FIG. 3 illustrates an example flowchart of various operations performed by the healthcare communication system disclosed herein. Specifically, a receiving operation 302 receives patient identifying information from a patient of the patient's representative. For example, if a patient is a minor patient, the information may be provided by the patient's parents. Subsequently, an identifying operation 304 identifies several multimedia content that may be presented to the patient. For example, if the patient identifying information includes the patient's reason for visiting the healthcare provider as being flu symptoms, the identifying operation 304 identifies various instructional videos related to flu symptoms, precautions, etc. In one implementation, rather than providing a lone video describing the final diagnosis, the healthcare communication system provides a suite of videos throughout the health care episode tailored to each individual. Just as each patient may have unique presentation and diagnostic results, the ensemble of videos will be uniquely tailored to that patient. We employ algorithms to filter videos based on chief complaint, demographics, response to therapy, and diagnostic testing. A unique combination of videos will be presented to patients throughout their episode of care.

Subsequently, a receiving operation 306 receives a selection from the patient about viewing one or more of the multimedia content presented to the patient. In response to such selection, a displaying operation 308 displays the multimedia content to the patient using a tablet device, via a computer terminal, etc. In one implementation, the content available to the patient or the content being displayed to the patient is dynamically updated based on one or more input from the patient, one or more inputs from physicians, nurses, etc. Thus, for example, during the patient's viewing of the content, a physician may review the feedback from the patient and update the content delivered to the patient. Another receiving operation 312 received feedback from the patient of other party viewing the content. A providing operation 314 provides post-treatment feedback from the patient to the healthcare provider and from the healthcare provider to the patient.

In one implementation, the displaying operation 308 delivers real-time content to patient (consumer of content) based on patient demographics and presenting complaint. Further video content is dynamically delivered based on new information (test results, change in patient condition, family or friend arrival). In addition to a suite of content available for delivery via the web application interface, custom video content can be created by any individual medical provider (physician, physician assistant, nurse practitioner, nurse) or any health care site administrator. In addition, videos can be used to obtain informed consent for a procedure.

As an example, a twenty (20) year old female with abdominal pain may have an ultrasound and labs to assess for pregnancy. Whereas a seventy (70) year old male with abdominal pain may have labs, an EKG, and a CAT scan to accesses for diverticulitis. While both patients may ultimately end up with appendicitis, their diagnostic approach could be vastly different. The videos would reflect these differences and navigate both patients through their episode of care via different pathways.

In one implementation, in addition to videos, instant messaging (IM) (or more widely any sort of text messaging communication) is also integrated into the communication suite. As a result, healthcare providers are able to send IMs from both mobile and stationary platforms to patients. For example, a provider may send both pre-formatted and customized IMs to a patient. Furthermore, patients have the opportunity to send pre-formatted IMs to their health care providers. Pre-formatted IMs will be codified to reflect the severity of complaint or assigned priority based on their importance. For example, an IM from a patient indicating they have chest pain would be given higher priority than an IM requesting a drink of water. Physicians and nurses are also able to communicate using IMs.

Yet alternatively, IM content is dynamically delivered based on new information (test results, change in patient condition, family or friend arrival). In addition to the suite of provided IM's, an implementation also allows individual providers to create custom IM content. Further communication via IM or email can be delivered to patient families on their own devices such as smartphone or desktop.

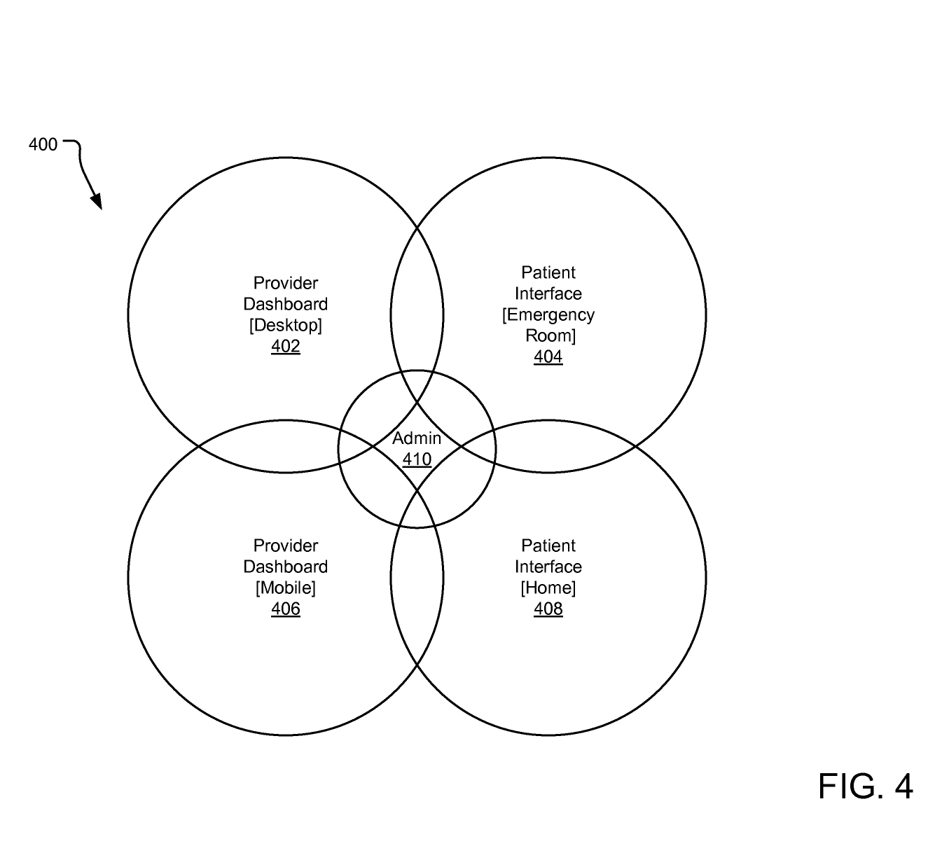

FIG. 4 illustrates a block diagram of various user interfaces 400 used by the healthcare communication system. Specifically, the interfaces 400 include a desktop provider dashboard 402, a patient interface 404 for use at healthcare facility, a mobile provider dashboard 406, a patient interface 408 for remote use, and an administration interface 410. For example, the desktop provider dashboard 402 allows physicians, physician assistants (PAs), nurses, and other parties to have an overview of all active patients and assign content to individual patient rooms. For example, the information collected by the desktop provider dashboard 402 include:
Physician Names
Midlevel Names
Nurse Names
Patient Chief Complaint
Videos (Introduction, Testing, Disposition)
Instant Messages
Send survey for satisfaction
Print After Care Instructions to view video at home
Warnings for test of understanding
Warnings for poor satisfaction score

In one implementation, this is the main application screen where users could assign new patients to rooms as well as assign chief complaint. Here, providers, videos, instant messages, and surveys could be assigned.

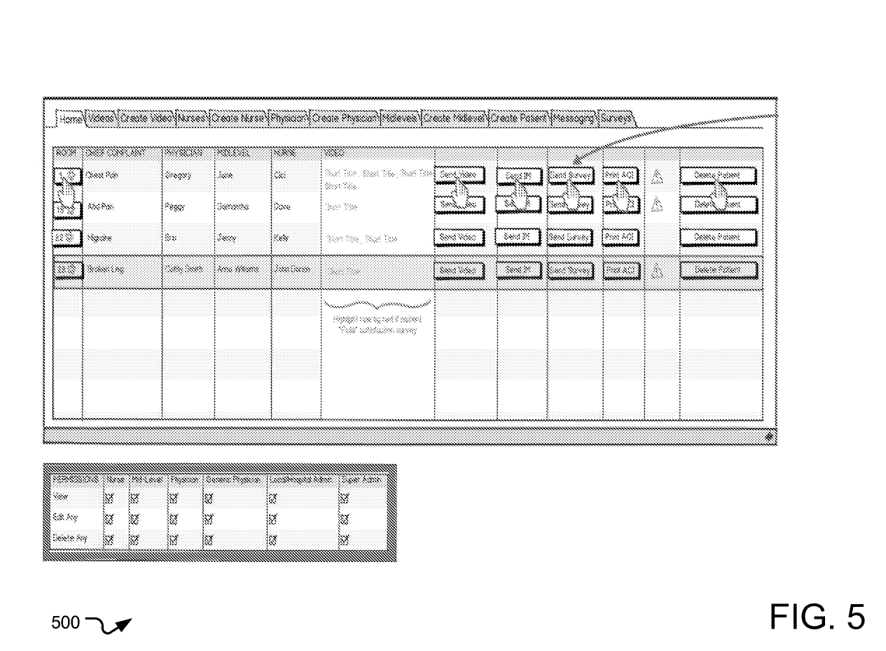

FIG. 5 illustrates an example desktop user interface 500 that may be used by the healthcare communication system. The desktop version 500 has a mobile analog that offers much of the same functionality. The dashboard also indicates progress of visit. Videos are color coded to indicate their status (in queue, complete, problem). Warnings are displayed here if patients do not demonstrate understanding of videos (via question/quiz), or if patients are not satisfied with their visit. After care instructions are generated here. The aftercare instructions include a printed sheet with a link to website and a personal code to allow patients to view their video(s) from home. Lastly, this screen provides access to administrative functions covered below, such as adding a new patient, assigning a video, etc.

To add a new patient, provider selects “Create Patient.” This links to following screen. A hidden field assigns an alphanumeric code that would later be used on aftercare instructions for patient home access to videos. Rooms are selected by drop down menu, physicians, mid-level providers (physician assistant, nurse practitioner, resident, intern), and nurses are selected by drop down menu. If a provider is logged on, their name is automatically preselected. Videos are also assigned on this screen. First, a chief complaint is selected. The chief complaints are then used to dynamically filter which videos are to be displayed in the next group of drop down menus. The chief complaint may limit videos specific to a particular part of body, patient gender, or age. For example, if a chief complaint of ‘Vaginal Bleeding’, only videos geared to female gender, non-pediatric age group, are displayed. Some chief complaints may span gender and age groups. For example ‘Cough’ video may apply to all ages, all genders.

The videos are also filtered and grouped according to time in episode of care. In one implementation, three primary groups exist: Introduction, Testing and Procedures, and Disposition. For example, in a chest pain episode, the patient may start with a video giving broad explanation of chest pain (cause, potential dangerous conditions, expectations about time for diagnostic work up, initial diagnostic steps and introduction to providers). There may be more than one introduction video depending on the chief complaints. Similarly, patients may have more than one complaint, so multiple complaints are allowed and filters allow for a union of videos based on all selected complaints.

The second group of videos is Testing and Procedures. Videos based on pending tests may be selected. The selection process may be either manual or automatic. In the manual scenario, providers select a video for a test or procedure. Again, the selection options are filtered by chief complaint(s). For example, if a patient had a chief complaint of chest pain, the provider has the option of selecting videos relating to chest pain (e.g. Chest X-Ray, Chest CT scan, EKG, etc.). Those videos not related to chest pain (e.g. Obstetric Ultrasound) are not being displayed. This serves two purposes: it limits the field of videos to a manageable number, and it reduces the likelihood that an incorrect video is shown to a patient.

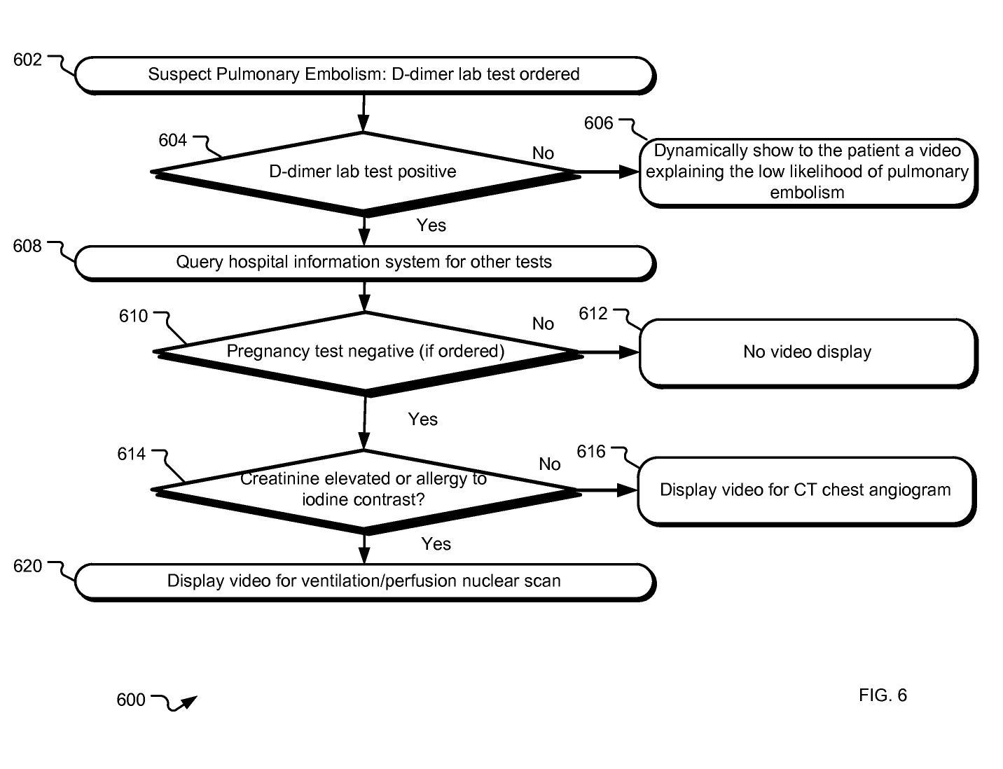

FIG. 6 illustrates an alternative example flowchart 600 of various operations performed by the healthcare communication system disclosed herein. Specifically, flowchart 600 illustrates the automatic selection of videos. In the automatic scenario, and interface communicates between the system disclosed herein and a hospital information system. Once certain tests are ordered by the provider, videos are automatically placed in the queue for display to the patient. For example, if a provider orders a CT scan of the abdomen, the patient is presented a video explaining the process and timing of getting this study. Intelligent algorithms allow for predicting and displaying videos relevant to the individual patient. For example, suppose a patient is being worked up for potential pulmonary embolism. At operation 602 a blood test called D-Dimer is ordered. An operation 604 evaluates the results of the test. If D-dimer is negative, the likelihood of pulmonary embolism is low and a video explaining that this diagnosis is unlikely is displayed automatically to the patient, as illustrated by operation 606. If, however the D-Dimer is positive, further testing is indicated.

The operation 610 is evaluation of a pregnancy test. If the results of the pregnancy test are negative as per operation 612 no videos are displayed. An operation 614 evaluates the creatinine levels. If a patient had abnormal renal function (determined by abnormal lab value, creatinine) or if the patient had a documented allergy to iodine contrast material, the preferred imaging study would be a ventilation/perfusion nuclear (VQ) lung scan, as illustrated by operation 620. In this case a video describing the VQ scan would automatically be displayed to the patient. If renal function is normal, and no allergies are documented, then the preferred imaging study is CT Angiogram of the chest, as illustrated by operation 618. A video describing this study is automatically displayed. Thus, the system disclosed herein organizes videos and then displays them automatically based on real time patient data.

An interface uses color-coding to indicate video progress. For example, videos still in patient queue are blue, videos already viewed are green, and if problems occurred, video names are red. This helps ensure that duplicate videos are not displayed and alerts provider if problems exist.

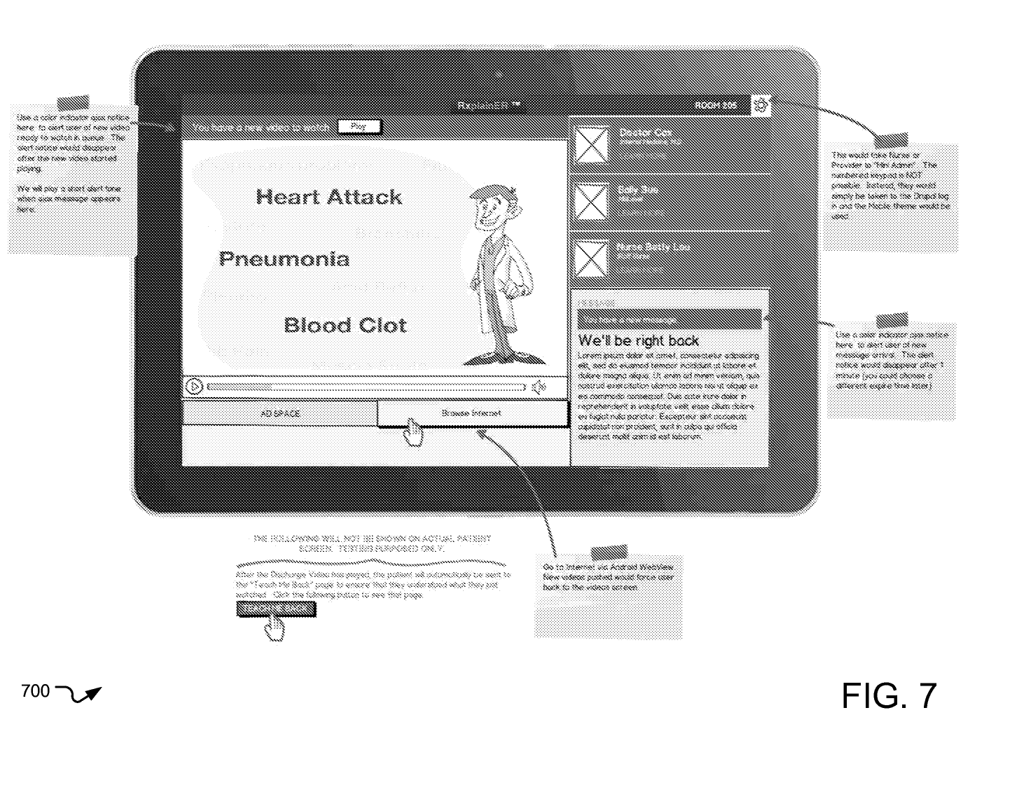

FIG. 7 illustrates an alternative example user interface 700 that may be used by the healthcare communication system disclosed herein. The user interface 700 is presented to a patient and it allows the patient to get information about various healthcare providers and to watch videos related to his or her condition. In an alternative implementation, the user interface 800 may be used by the patient for individualized browsing experience. For example, the system may select various information about the patient's condition, lab results, etc., and open an Internet browser with the information. Thus, for example, if the patient is diagnosed with Tuberculosis, the user interface provides Wikipedia page with information about Tuberculosis, a WedMD page with information about Tuberculosis, etc. In an alternate implementation, the user interface 700 may also display hospital branded advertising, an affiliate sponsored advertising, an affiliate advertising, a sponsored advertising, links to additional healthcare services portals, etc.

In an alternative implementation, the user interface 700 may also be used to receive authorization from a patient to provide communications to the patient's friends, relatives, etc. For example, the patient may authorize sending the room number assigned to the patient to his family members, updating of his or her condition to be sent to family members, etc.

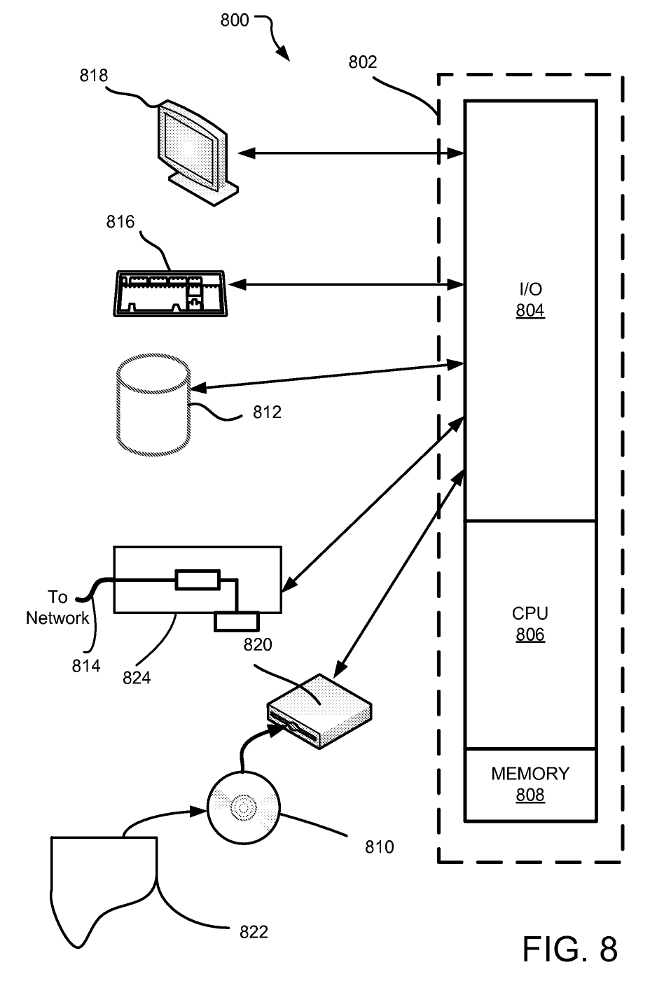

FIG. 8 illustrates an example computing system that can be used to implement one or more components of the healthcare communication system method and system described herein. A general-purpose computer system 800 is capable of executing a computer program product to execute a computer process. Data and program files may be input to the computer system 800, which reads the files and executes the programs therein. Some of the elements of a general-purpose computer system 800 are shown in FIG. 8, wherein a processor 802 is shown having an input/output (I/O) section 804, a Central Processing Unit (CPU) 806, and a memory section 808. There may be one or more processors 802, such that the processor 802 of the computer system 800 comprises a single central-processing unit 806, or a plurality of processing units, commonly referred to as a parallel processing environment. The computer system 800 may be a conventional computer, a distributed computer, or any other type of computer such as one or more external computers made available via a cloud computing architecture. The described technology is optionally implemented in software devices loaded in memory 808, stored on a configured DVD/CD-ROM 810 or storage unit 812, and/or communicated via a wired or wireless network link 814 on a carrier signal, thereby transforming the computer system 800 in FIG. 8 to a special purpose machine for implementing the described operations.

The I/O section 804 is connected to one or more user-interface devices (e.g., a keyboard 816 and a display unit 818), a disk storage unit 812, and a disk drive unit 820. Generally, in contemporary systems, the disk drive unit 820 is a DVD/CD-ROM drive unit capable of reading the DVD/CD-ROM medium 810, which typically contains programs and data 822. Computer program products containing mechanisms to effectuate the systems and methods in accordance with the described technology may reside in the memory section 804, on a disk storage unit 812, or on the DVD/CD-ROM medium 810 of such a system 800, or external storage devices made available via a cloud computing architecture with such computer program products including one or more database management products, web server products, application server products and/or other additional software components. Alternatively, a disk drive unit 820 may be replaced or supplemented by a floppy drive unit, a tape drive unit, or other storage medium drive unit. The network adapter 824 is capable of connecting the computer system to a network via the network link 814, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 800 is connected (by wired connection or wirelessly) to a local network through the network interface or adapter 824, which is one type of communications device. When used in a WAN-networking environment, the computer system 800 typically includes a modem, a network adapter, or any other type of communications device for establishing communications over the wide area network. In a networked environment, program modules depicted relative to the computer system 800 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 808 or other storage systems, such as disk storage unit 812 or DVD/CD-ROM medium 810 and/or other external storage device made available and accessed via a cloud computing architecture. Still further, some or all of the operations for the system for healthcare communication system disclosed herein may be performed by the processor 802. In addition, one or more functionalities of the system disclosed herein may be generated by the processor 802 and a user may interact with these GUIs using one or more user-interface devices (e.g., a keyboard 816 and a display unit 818) with some of the data in use directly coming from third party websites and other online sources and data stores via methods including but not limited to web services calls and interfaces without explicit user input.

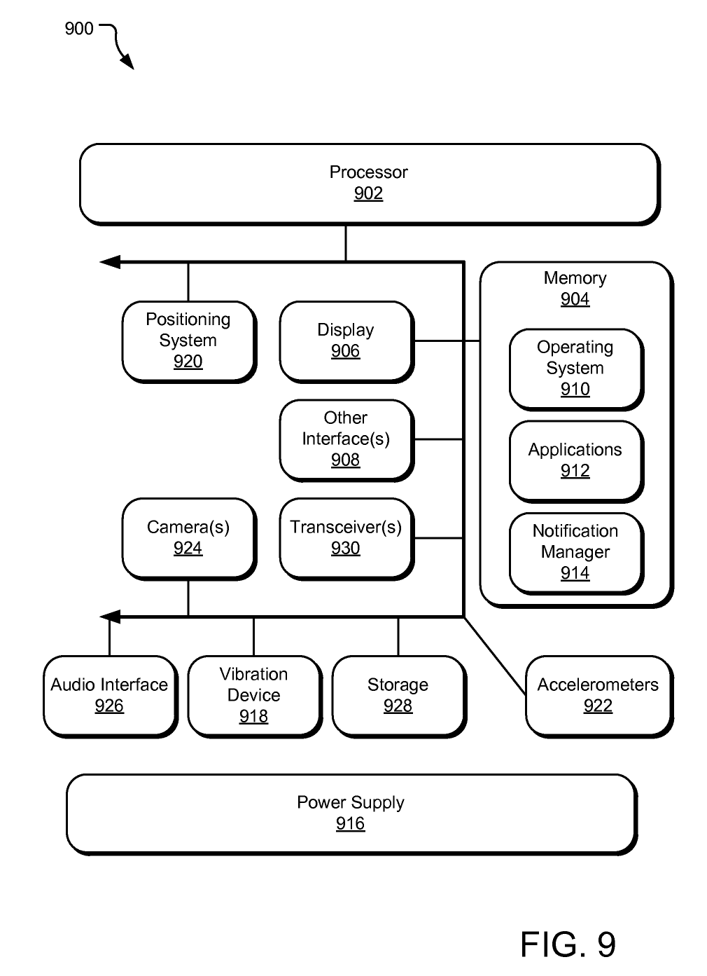

FIG. 9 illustrates an example mobile computing device 900 that can be used to implement one or more components of the healthcare communication system disclosed herein. Specifically, the mobile computing device 900. The mobile device 900 includes a processor 902, a memory 904, a display 906 (e.g., a touchscreen display), and other interfaces 908 (e.g., a keyboard). The memory 904 generally includes both volatile memory (e.g., RAM) and non-volatile memory (e.g., flash memory). An operating system 910, such as the Microsoft Windows® Phone 7 operating system, resides in the memory 904 and is executed by the processor 902, although it should be understood that other operating systems may be employed.

One or more application programs 912 are loaded in the memory 904 and executed on the operating system 910 by the processor 902. Examples of applications 912 include without limitation email programs, scheduling programs, personal information managers, Internet browsing programs, multimedia player applications, etc. In one implementation, an healthcare communication system application stored in the memory 904 may be used to catalog various observations stored on the mobile device 900, such as e-mail addresses from the e-mail application of the mobile device, the contacts from a contact management application stored on the mobile device 900, etc. In yet alternate implementation, a client application stored in the memory 904 of the mobile device 900 may generate queries using the information stored on the mobile device 900, receive entity relation information from a server generating relations between various elements, and display updated observations to a user of the mobile device 900. A notification manager 914 is also loaded in the memory 904 and is executed by the processor 902 to present notifications to the user. For example, when a promotion is triggered and presented to the shopper, the notification manager 914 can cause the mobile device 900 to beep or vibrate (via the vibration device 918) and display the promotion on the display 906.

The mobile device 900 includes a power supply 916, which is powered by one or more batteries or other power sources and which provides power to other components of the mobile device 900. The power supply 916 may also be connected to an external power source that overrides or recharges the built-in batteries or other power sources.

The mobile device 900 includes one or more communication transceivers 930 to provide network connectivity (e.g., mobile phone network, Wi-Fi®, BlueTooth®, etc.). The mobile device 900 also includes various other components, such as a positioning system 920 (e.g., a global positioning satellite transceiver), one or more accelerometers 922, one or more cameras 924, an audio interface 926 (e.g., a microphone, an audio amplifier and speaker and/or audio jack), and additional storage 928. Other configurations may also be employed.

Embodiments of the present technology are disclosed herein in the context of a healthcare communication system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method of, comprising:
selecting from a plurality of patient communication content;
delivering the selected patient communication content to a patient;
monitoring viewing of the patient communication content by the patient;
automatically generating, using a processor, a feedback based on the viewing of the patient communication content by the patient; and
distributing the feedback to one or more of a plurality of healthcare system participants.

2. The method of claim 1, wherein the patient communication content is patient education content.

3. The method of claim 1, wherein selecting the selected patient communication content further comprises selecting the patient communication content automatically based on one or more of a plurality of patient data.

4. The method of claim 1, further comprising:
assigning a user role to one or more participants; and
associating one or more of a plurality of patient communication content to one or more of the user roles,
wherein delivering the patient communication content further comprises delivering the patient communication content by the participant having a user role associated with the patient communication content.

5. The method of claim 1 further comprising:
generating a matrix identifying the patient communication content delivered to the patient; and
displaying the matrix on one or more user devices used by the healthcare system participants.

6. The method of claim 5 further comprising automatically updating the matrix based on a viewing status of the patient communication content.

7. The method of claim 5 further comprising automatically updating the matrix based on a patient status during a patient episode.

8. The method of claim 5 further comprising including a symbol in the matrix along with one or more of the patient communication content in the matrix, wherein the symbol relates to a patient question, a patient response to a question, or a patient comment related to the patient communication content.

9. The method of claim 1, wherein delivering the selected patient communication further comprises delivering the patient communication content via a tablet computer.

10. The method of claim 1, further comprising receiving a plurality of information from the patient, wherein selecting from the plurality of patient communication content further comprises selecting from the plurality of patient communication content based on one or more of the plurality of information from the patient.

11. The method of claim 1, further comprising receiving a plurality of information from a government data source, wherein selecting from the plurality of patient communication content further comprises selecting from the plurality of patient communication content based on one or more of the plurality of information from the government data source or from a third party insurer.

12. The method of claim 1, further comprising receiving a plurality of social network content related to the patient, wherein selecting from the plurality of patient communication content further comprises selecting from the plurality of patient communication content based on one or more of the plurality of information from the social network content related to the patient.

13. The method of claim 1, further comprising archiving the viewing of patient communication content to establish compliance with one or more patient communication regulations.

14. The method of claim 1, further comprising:
organizing a plurality of patient communication content based on plurality of medical conditions;
receiving real-time information about the patient's medical condition; and
selecting one of the plurality of patient communication content based on the patient's medical condition.

15. The method of claim 14, wherein the real-time information is selected by a healthcare provider and supplemented based on one or more patient inputs.

16. The method of claim 14, wherein the real-time information is based on one or more testing results.

17. The method of claim 14, wherein the real-time information is based on at least one of social network of the patient, geographic location of the patient, primary residence location of the patience, and insurance status of the patient.

18. A system comprising:
a database for storing a plurality of patient communication content, wherein each of the patient communication content is associated with one of more healthcare condition;
a first memory comprising one or more computer readable instructions to select one or more of the plurality of patient communication content based on a patient condition;
a first communication module configured to communicate the selected patient communication content to a patient;
a mobile device configured to display the patient communication content to the patient;
a monitoring module configured to monitor the viewing of the patient communication content by the patient;
a second memory comprising one or more computer readable instructions to generate a matrix representing the viewing of the patient communication content by the patient; and
a second communication module configured to communicate the matrix to one or more healthcare system participants.

19. The system of claim 18, wherein the first memory further comprising one or more computer readable instructions to update the selection of one or more of the plurality of patient communication content based on a real time update to the patient condition.

20. One or more tangible computer-readable storage media storing computer executable instructions for performing a computer process on a computing system, the computer process comprising:
organizing a plurality of patient communication content based on plurality of medical conditions;
receiving a patient status on a healthcare episode;
selecting from a plurality of patient communication content based on the patient status on the healthcare episode;
delivering the selected patient communication content to a patient via a mobile device;
monitoring viewing of the patient communication content by the patient;
receiving, via the mobile device, an input from the patient regarding the patient's viewing of the patient communication content;
automatically generating a matrix based on the viewing of the patient communication content by the patient and the patient input, wherein each of the patient communication content listed in the matrix is identified by at least one of a patient viewing status and a symbol identifying the patient input; and
distributing the matrix to one or more of a plurality of healthcare system participants.
